(19) United States
(12) Patent Application Publication
(10) Pub. No.: US 2025/0104005 A1
(43) Pub. Date: Mar. 27, 2025

(54) DRONE DELIVERY SYSTEM

(71) Applicants: Sadeq Albakri, Petersburg, VA (US); Noman Algahim, Monroe, NC (US)

(72) Inventors: Sadeq Albakri, Petersburg, VA (US); Noman Algahim, Monroe, NC (US)

(21) Appl. No.: 18/892,358

(22) Filed: Sep. 21, 2024

Related U.S. Application Data
(60) Provisional application No. 63/540,570, filed on Sep. 26, 2023.

(51) Int. Cl. G06Q 10/0836; B64U 10/14; B64U 101/64

(52) U.S. Cl. CPC G06Q 10/0836; B64U 10/14; B64U 2101/64

(57) ABSTRACT

A drone delivery system including a delivery box securely attached to a surface adjacent a building structure, and a drone mechanism adapted to electronically interact with the delivery box, control the delivery box, and securely place a package within the delivery box, and wherein the system is adapted to scan packages and send delivery notification texts and emails.

### CROSS-REFERENCE TO RELATED APPLICATION

The present application is related to and claims priority from prior provisional application Ser. No. 63/540,570, filed Sep. 26, 2023 which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to package delivery systems, and more specifically to package delivery systems using drones and drone technology.

### 2. Description of the Related Art

Prior art package delivery systems includes delivery boxes attached to a surface adjacent a building structure, and include mechanisms to deliver a package thereto, including in person deliveries. However, in person deliveries are only achieved during certain business hours and are subject to the availability of delivery people and their vehicles. As such, deliveries take a certain amount of time, are inconsistent, and unreliable, which is unacceptable in many circumstances. Furthermore, most delivered packages are simply placed on the ground next to a building structure for pick up. This method is very unsecure and theft is prevalent. Thus, a need exists for a drone delivery system to avoid the above-mentioned problems.

Accordingly, the present invention overcomes the disadvantages associated with the prior art, by providing a drone delivery system including a delivery box securely attached to a surface adjacent a building structure, and a drone mechanism adapted to electronically interact with the delivery box, control the delivery box, and securely place a package within the delivery box, and wherein the system is adapted to scan packages and send delivery notification texts and emails.

### BRIEF SUMMARY OF THE INVENTION

In view of the foregoing disadvantages inherent in the known types of delivery systems or the like in the prior art, the present invention provides a novel drone delivery system including a delivery box securely attached to a surface adjacent a building structure, and a drone mechanism adapted to electronically interact with the delivery box, control the delivery box, and securely place a package within the delivery box, and wherein the system is adapted to scan packages and send notification delivery texts and emails. As such, the general purpose of the present invention, which will be described subsequently in greater detail, is to provide a drone delivery system with all the advantages of the prior art and none of the disadvantages.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

The figures which accompany the written portion of this specification illustrate embodiments according to the teachings of the present invention.

FIG. 1 shows a perspective view of the drone delivery system according to the preferred embodiment of the present invention.

FIG. 2 shows a perspective view illustrating the drone mechanism of the drone delivery system according the preferred embodiment of the present invention of FIG. 1.

FIG. 3 shows a perspective view illustrating the delivery box of the drone delivery system according the preferred embodiment of the present invention of FIG. 1.

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

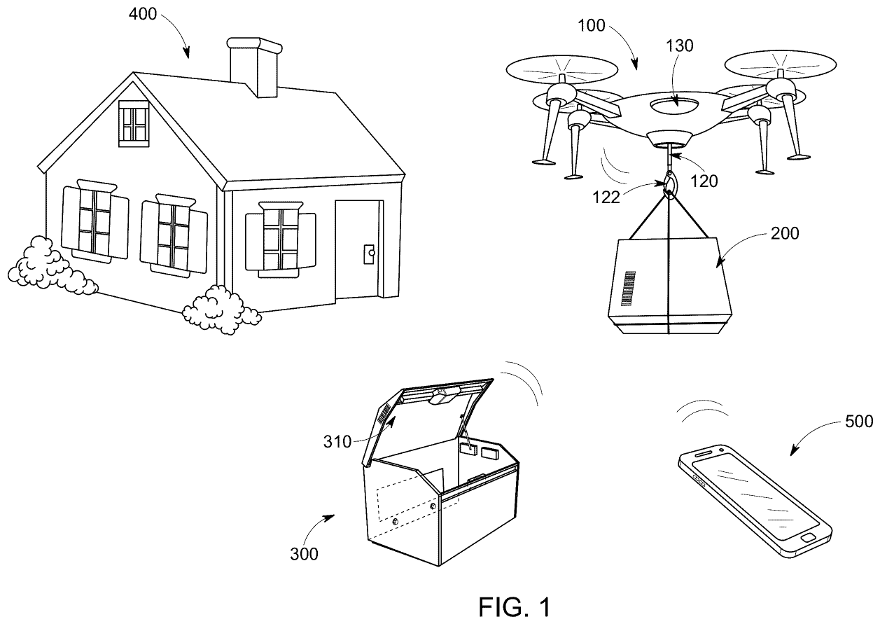

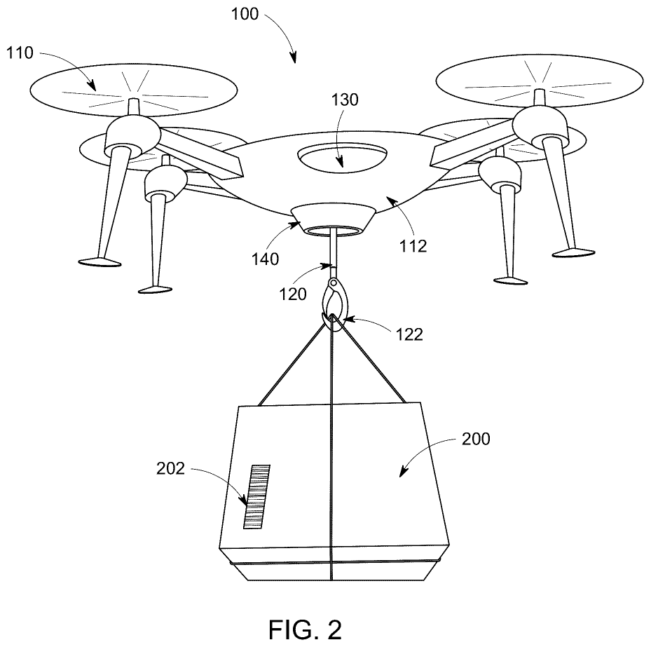

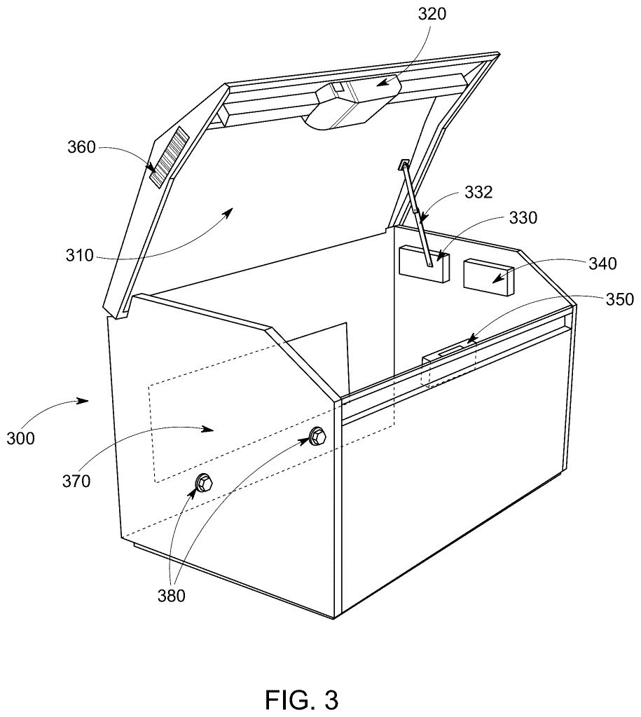

Referring now to the drawings FIGS. 1-3, the drone delivery system includes a drone mechanism 100 and a delivery box 300. The delivery box 300 includes at least one side wall, a bottom wall, and a movable top wall 310 forming an interior volume, wherein the movable top wall 310 is movably attached to the at least one side wall to thereby allow and deny access to the interior volume. The delivery box 300 further includes a top wall motor 330 and motor arm 332 attached between the movable top wall 310 and the at least one side wall, to thereby move the top wall from a closed position to an open position allowing access to the interior volume, and from an open position to a closed position to thereby close and secure the interior volume. The delivery box 300 further includes a transceiver 340 located within the interior volume of the delivery box and is adapted to control the top wall motor 330, and wherein the transceiver 340 is adapted to communicate wirelessly with drone mechanism 100 which is used to deliver packages 200 to the delivery box 300, such that the drone mechanism 100 can control the top wall motor and open and close the top wall of the delivery box during deliveries.

The drone mechanism 100 includes a hollow main body 112 forming an interior volume; a lift mechanism 110, in the preferred embodiment includes a plurality of propellers, connected to an outer surface of the main body and is adapted to lift the drone mechanism 100 into the air and into flight; a package retrieval mechanism 120 connected to the main body and is adapted to releasably attach to and retrieve a package 200 to be delivered to the delivery box 300; a transceiver 130 located within said interior volume of said main body and is adapted to communicate wirelessly with the transceiver 340 of the delivery box, such that the drone mechanism 100 can locate the delivery box 300 and open and close the top wall of the delivery box, wherein a package 200 is attached to the drone mechanism 100 via the package retrieval mechanism 120, flown through the air to the delivery box 300, the top wall 310 opened by the drone mechanism, the package placed within the interior volume of the delivery box, the package detached from the drone mechanism package retrieval mechanism 120, and the top wall closed by the drone mechanism.

The movable top wall 310 may be pivotally attached to the at least one side wall, and wherein the delivery box 300 further includes a locking mechanism 350 for releasably retaining the movable top wall 310 to the at least one side wall, and wherein the locking mechanism 350 is adapted to be controlled by the delivery box transceiver 340. The delivery box 300 further includes a scanner 320 adapted to scan packages as they are being inserted into the interior volume thereof, and wherein the scanner is adapted to retrieve information from the packages and send that information to the delivery box transceiver 340 for sending delivery notification texts and emails to a computer device, for example, a smart phone 500.

The drone mechanism 100 may further include a scanner 140 as well and adapted to scan packages before they are attached to the lift mechanism 120; and wherein the scanner is adapted to retrieve information from the packages, usually via bar codes 202, and send that information to the drone mechanism transceiver 130 for sending retrieval notification texts and emails to a computer device. The package retrieval mechanism 120 may be formed including a winch and a flexible wire attached to and adapted to wrap around the winch, and a releasable gripping mechanism 122 attached to an end section of the flexible wire. Other embodiments and variations of the releasable gripping mechanism 122 can alternatively be used, for example ropes, magnets, hooks, clamps, and obvious variations thereof.

The delivery box 300 may further include fasteners 380 adapted to securely attach it to an external wall of a building structure 400. The delivery box 300 may further include a bar code 360 on an external surface of the movable top wall 310, such that the drone mechanism scanner 140 can scan the bar code 360 and determine the validity of the proper delivery box. The delivery box 300 may further include padding therein for protecting fragile packages and or insulating materials therein for protecting packages from rain, snow, ice, and cold weather.

The delivery box 300 is also adapted to open automatically when a package arrives via the drone mechanism 100. This may be accomplished in many ways, including through BLUETOOTH™ or Wi-Fi. The delivery box 300 can also be designed to expand or contract to facilitate packages of varying sizes. Furthermore, the delivery box 300 may also be equipped with a back door 370 that can be opened by a homeowner when retrieving packages.

When in use, during delivery, a package 200 may simply touch the surface of the delivery box 300, or be in proximity thereof, to trigger the opening of the delivery box 300. The delivery box 300 may also be opened using a touch pad and pass code. Furthermore, the delivery box 300 can be made aesthetically pleasing such that it adds beauty to a home's garden.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. A delivery box comprising:
at least one side wall;
a bottom wall; and
a movable top wall;
wherein said at least one side wall, said bottom wall, and said movable top wall form an interior volume;
wherein said movable top wall is movably attached to said at least one side wall to thereby allow and deny access to said interior volume;
a top wall motor;
wherein said top wall motor is attached between said movable top wall and said at least one side wall, to thereby move said top wall from a closed position to an open position allowing access to said interior volume, and from an open position to a closed position to thereby close and secure said interior volume; and
a transceiver;
wherein said transceiver is located within said interior volume of said delivery box and is adapted to control said top wall motor; and
wherein said transceiver is adapted to communicate wirelessly with a drone mechanism used to deliver packages to said delivery box, such that said drone mechanism can control said top wall motor and open and close said top wall of said delivery box.

2. The delivery box of claim 1, wherein said movable top wall is pivotally attached to said at least one side wall.

3. The delivery box of claim 1, wherein said delivery box further includes a locking mechanism for releasably retaining said movable top wall to said at least one side wall; and wherein said locking mechanism is adapted to be controlled by said delivery box transceiver.

4. The delivery box of claim 1, wherein said delivery box further includes a scanner adapted to scan packages as they are being inserted into said interior volume thereof; and wherein said scanner is adapted to retrieve information from said packages and send said information to said delivery box transceiver for sending delivery notification texts and emails.

5. The delivery box of claim 1, wherein said delivery box further includes fasteners adapted to securely attach said delivery box to an external wall of a building structure.

6. The delivery box of claim 1, wherein said delivery box further includes a bar code on an external surface of said movable top wall, such that a drone mechanism scanner can scan said bar code and determine the validity of said delivery box.

7. The delivery box of claim 1, wherein said delivery box further includes padding therein for protecting fragile packages.

8. The delivery box of claim 1, wherein said delivery box includes further includes insulating materials therein for protecting packages from rain, snow, ice, and cold weather.

9. A drone delivery system comprising:
a delivery box including:
at least one side wall;
a bottom wall; and
a movable top wall;
wherein said at least one side wall, said bottom wall, and said movable top wall form an interior volume;
wherein said movable top wall is movably attached to said at least one side wall to thereby allow and deny access to said interior volume;
a top wall motor;
wherein said top wall motor is attached between said movable top wall and said at least one side wall, to thereby move said top wall from a closed position to an open position allowing access to said interior volume, and from an open position to a closed position to thereby close and secure said interior volume; and
a transceiver;
wherein said transceiver is located within said interior volume of said delivery box and is adapted to control said top wall motor; and
wherein said transceiver is adapted to communicate wirelessly with a drone mechanism used to deliver packages to said delivery box, such that said drone mechanism can control said top wall motor and open and close said top wall of said delivery box; and
a drone mechanism including:
a hollow main body including:
an interior volume;
a lift mechanism;
wherein said lift mechanism is connected to an outer surface of said main body and adapted to lift said drone mechanism into the air and into flight;
a package retrieval mechanism;
wherein said package retrieval mechanism is connected to said main body and adapted to releasably attach to and retrieve a package to be delivered to said delivery box;
a transceiver;
wherein said transceiver is located within said interior volume of said main body and is adapted to communicate wirelessly with said transceiver of said delivery box, such that said drone mechanism can locate said delivery box and open and close said top wall of said delivery box;
wherein a package is attached to said drone mechanism via said package retrieval mechanism, flown through the air to said delivery box, the top wall opened by said drone mechanism, the package placed within said interior volume of said delivery box, the package detached from said drone mechanism package retrieval mechanism, and said top wall closed by said drone mechanism.

10. The drone delivery system of claim 9, wherein said movable top wall is pivotally attached to said at least one side wall.

11. The drone delivery system of claim 9, wherein said delivery box further includes a locking mechanism for releasably retaining said movable top wall to said at least one side wall; and wherein said locking mechanism is adapted to be controlled by said delivery box transceiver.

12. The drone delivery system of claim 9, wherein said delivery box further includes a scanner adapted to scan packages as they are being inserted into said interior volume thereof; and wherein said scanner is adapted to retrieve information from said packages and send said information to said delivery box transceiver for sending delivery notification texts and emails.

13. The drone delivery system of claim 9, wherein said drone mechanism further includes a scanner adapted to scan packages before they are attached to said lift mechanism; and wherein said scanner is adapted to retrieve information from said packages and send said information to said drone mechanism transceiver for sending retrieval notification texts and emails.

14. The drone delivery system of claim 9, wherein said package retrieval mechanism further includes a winch, a flexible wire attached to and adapted to wrap around said winch, and a releasable gripping mechanism attached to an end section of said flexible wire.

15. The drone delivery system of claim 9, wherein said delivery box further includes fasteners adapted to securely attach said delivery box to an external wall of a building structure.

16. The drone delivery system of claim 9, wherein said delivery box further includes a bar code on an external surface of said movable top wall, such that said drone mechanism scanner can scan said bar code and determine the validity of the proper delivery box.

17. The drone delivery system of claim 9, wherein said delivery box further includes padding therein for protecting fragile packages.

18. The drone delivery system of claim 9, wherein said delivery box includes further includes insulating materials therein for protecting packages from rain, snow, ice, and cold weather.
